(19) United States
(12) Patent Application Publication
(10) Pub. No.: US 2026/0138381 A1
(43) Pub. Date: May 21, 2026

(54) Air dryer

(71) Applicant: Videojet Technologies Inc., Wood Dale, IL (US)

(72) Inventors: Simon Philip Jelley; Timothy Kenneth Hartley; Matthias Lothar Heinz Ediger

(21) Appl. No.: 19/120,238

(22) PCT Filed: Oct. 10, 2023
(86) PCT No.: PCT/GB2023/052618

§ 371 Date: Apr. 11, 2025

(30) Foreign Application Priority Data
Oct. 11, 2022 (GB) 2214952.0

(51) Int. Cl. B41J 11/00; B41J 2/02

(52) U.S. Cl. CPC B41J 11/0022; B41J 2/02

(57) ABSTRACT

An air dryer (1) is provided for use with an ink jet printer (50) comprising a print head (15) for applying an inked image (18) to a substrate (16). The air dryer (1) comprises: a housing (2) enclosing an internal space (3) therein: an air supply (5) configured to supply air into the internal space (3) of the housing: a heating element (6) configured to heat the air; and an air guide (8) in communication with the internal space (3). The air guide (8) is configured to direct a jet of the heated air (10) at the inked image (18) on the substrate (16) so as to dry the inked image (18). The air guide (8) is configured such that the jet of the heated air (10) between the air guide 8 and the substrate (16) forms an angle θ of between 0 and 30 degrees relative to a direction of travel X of the substrate (16).

### TECHNICAL FIELD

This disclosure relates to an air dryer for use with an ink jet printer comprising a print head for applying an inked image to a substrate. More particularly, but not exclusively, the present disclosure relates to an air dryer for use with a continuous ink jet printer to dry an inked image printed by the continuous ink jet printer using water-based inks.

### BACKGROUND

Ink jet printing systems are used in a wide variety of printing applications. One such application is the printing of inked images (such as expiration dates, lot numbers etc.) on product packaging (referred to as substrates below) placed in high-speed automated production lines. In ink jet printing systems the print is made up of individual droplets of ink generated at a nozzle and propelled towards a substrate. There are two principal systems: drop on demand where ink droplets for printing are generated as and when required; and continuous ink jet printing in which droplets are continuously produced and only selected ones are directed towards the substrate, the others being recirculated to an ink supply. It would be understood that the ink droplets applied to the substrate would be wet immediately after printing, and the wet ink, if not dried quickly, presents handling problems as it can be easily smeared or smudged. When the printing process occurs as part of high-speed operations of production lines, it must be carried out rapidly and efficiently, i.e., the inked images must be applied and dried for further handling in a matter of seconds.

Continuous ink jet printers supply pressurised ink to a print head drop generator where a continuous stream of ink emanating from a nozzle is broken up into individual regular drops by, for example, an oscillating piezoelectric element. The drops are directed past a charge electrode where they are selectively and separately given a predetermined charge before passing through a transverse electric field provided across a pair of deflection plates. Each charged drop is deflected by the field by an amount that is dependent on its charge magnitude before impinging on the substrate whereas the uncharged drops proceed without deflection and are collected at a gutter from where they are recirculated to the ink supply for reuse. The charged drops bypass the gutter and hit the substrate at a position determined by the charge on the drop and the position of the substrate relative to the print head. Typically, the substrate is moved relative to the print head in one direction and the drops are deflected in a direction generally perpendicular thereto, although the deflection plates may be oriented at an inclination to the perpendicular to compensate for the speed of the substrate (the movement of the substrate relative to the print head between drops arriving means that a line of drops would otherwise not quite extend perpendicularly to the direction of movement of the substrate). The maximum width of the line of drops on the substrate in a direction perpendicular to the movement of the substrate may be referred to a print width of ink jet printers. The print width of a continuous ink jet printer is generally determined by a maximum deflection angle of the drops and a print distance between the print head and the substrate. The print width of a drop on demand ink jet printer may be determined by a width of a nozzle array in its print head.

In continuous ink jet printing a character is printed from a matrix comprising a regular array of potential drop positions. Each matrix comprises a plurality of columns (strokes), each being defined by a line comprising a plurality of potential drop positions (e.g. seven) determined by the charge applied to the drops. The maximum width of each column (i.e., the maximum width of the character) is defined by the print width of the continuous ink jet printer. Thus, each usable drop is charged according to its intended position in the stroke. If a particular drop is not to be used then the drop is not charged and it is captured at the gutter for recirculation. This cycle repeats for all strokes in a matrix and then starts again for the next character matrix.

Ink is delivered under pressure to the print head by an ink supply system that is generally housed within a sealed compartment of a cabinet that includes a separate compartment for control circuitry and a user interface panel. The system includes a main pump that draws the ink from a tank of the ink supply system via a filter and delivers it under pressure to the print head. As ink is consumed, the tank is refilled as necessary from a replaceable ink cartridge that is releasably connected to the tank by a supply conduit. The ink is fed from the tank via a flexible delivery conduit to the print head. The unused ink drops captured by the gutter are recirculated to the tank via a return conduit by a pump. The flow of ink in each of the conduits is generally controlled by solenoid valves and/or other like components.

As the ink circulates through the system, there is a tendency for it to thicken as a result of solvent evaporation, particularly in relation to the recirculated ink that has been exposed to air in its passage between the nozzle and the gutter. In order to compensate for this, “make-up” solvent is added to the ink as required from a replaceable solvent cartridge to maintain the ink viscosity within desired limits. This solvent may also be used for flushing components of the print head, such as the nozzle and the gutter, in a cleaning cycle. The solvent is typically a highly volatile chemical. Therefore, it is expected that a substantial amount of solvent be evaporated into the environment during the operation of a continuous ink jet printer.

Methyl ethyl ketone (MEK) and other solvents are widely used in the inks of continuous ink jet printers. However, these materials have the risk of being classified as carcinogens, mutagens or reproductive toxins (CMR) in the near future even though these are currently not classified as such. Another risk is that these solvents are classified as Volatile Organic Compounds (VOC), and subjected to the VOC regulation.

Water-based inks (in which water is the sole solvent) represent a promising solution of non-CMR and non-VOC inks for use with continuous ink jet printers. However, the drying time of water-based inks (due to natural evaporation) is around 20-25 seconds in a typical lab environment. In contrast, the typical drying time of MEK based inks is less than 2 seconds, and the typical drying time of Ethanol-based inks is less than 4 seconds. The long drying time of water-based inks presents handling problems of the printed substrates and thus reduces the efficiency of automated production lines.

It is therefore desirable to provide a drying device that can shorten the drying time of inked images printed on substrates by a continuous ink jet printer using water-based inks. It is an object of this disclosure, among others, to provide such a drying device.

### SUMMARY

According to a first aspect of the present disclosure, there is provided an air dryer for use with an ink jet printer comprising a print head for applying an inked image to a substrate, wherein the air dryer comprises: a housing enclosing an internal space therein; an air supply configured to supply air into the internal space of the housing; a heating element configured to heat the air; and an air guide in communication with the internal space for directing a jet of the heated air at the inked image on the substrate so as to dry the inked image, and wherein the air guide is configured such that the jet of the heated air between the air guide and the substrate forms an angle of between 0 and 30 degrees relative to a direction of travel of the substrate.

By configuring the air guide such that the jet of the heated air between the air guide and the substrate forms an angle of between 0 and 30 degrees relative to a direction of travel of the substrate, the jet of the heated air is blowing in a direction close to be in parallel with the direction of travel of the substrate. This arrangement is useful for maximising the contact time between the inked image/substrate and the heated air, thereby reducing the drying time of the inked image without consuming more electrical energy. As a result, the operating costs of the air dryer are relatively low. With the air dryer, it is possible to shorten the drying time of the inked image printed by water-based inks from 20-25 seconds to less than 5 seconds with less than 300 watts of electric power consumption.

The expression “the jet of the heated air between the air guide and the substrate” refers to a section of the jet that has just left the air guide but before arriving at any surface of the substrate. Hence, the jet between the air guide and the substrate travels along a direction which is primarily determined by the air guide, and is not substantially affected by a surface orientation of the substrate. It would be understood that the jet of the heated air between the air guide and the substrate travels along a substantially straight line.

The angle is measured at an intersection between the line along which the jet travels, and a line along which the substrate travels. For two intersecting lines that are not perpendicular to one another, there are two angles between the lines—an acute angle and an obtuse angle. The angle of between 0 to 30 degrees refers to the acute angle between the lines. In other words, the air guide is configured such that the jet between the air guide and the substrate forms an angle of between 0 and 30 degrees relative to a line parallel to a direction of travel of the substrate.

The heating element may be arranged between the air supply and the internal space. Alternatively, the heating element may be arranged within the internal space of the housing.

At least a part of the air guide may be attached to the housing, or may be integrally formed with the housing.

It would be understood that the term “in communication with” means “in fluid communication with” in the present disclosure.

The air guide may comprise a nozzle.

The nozzle may be attached to the housing, or may be integrally formed with the housing.

The angle may be between 0 and 20 degrees. Further or alternatively, the angle may be between 0 and 15 degrees, 5 and 30 degrees, 5 and 20 degrees or 5 and 15 degrees.

The angle may be approximately 10 degrees.

The air guide may comprise a tubular structure through which the jet of the heated air exits the internal space, and wherein the tubular structure forms an angle of between 0 and 30 degrees relative to the direction of travel of the substrate.

In other words, the tubular structure of the air guide defines a direction of the jet between the air guide and the substrate, and provides a simple mechanism to guide the heated air. A central axis of the tubular structure may form the angle of between 0 and 30 degrees relative to the direction of travel of the substrate.

The tubular structure may have any suitable cross-sectional shape, which is not limited to circular, oval, square, rectangular, polygonal or even non-geometrical, etc. Further, the tubular structure may have a varying cross sectional area along the central axis.

The angle may be between 0 and 20 degrees. Further or alternatively, the angle may be between 0 and 15 degrees, 5 and 30 degrees, 5 and 20 degrees or 5 and 15 degrees.

The angle may be approximately 10 degrees.

The air guide may be configured such that the jet between the air guide and the substrate has a velocity component that is opposite to the direction of travel of the substrate.

In other words, the air guide is placed at a downstream region of the print head along the direction of travel of the substrate, and the jet of the heated air is directed towards the print head.

By having the velocity component of the jet of the heated air to be opposite to the direction of travel of the substrate, the heated air can achieve a greater speed relative to the substrate, which is useful for reducing the drying time of the inked image. Therefore, this arrangement allows power savings to be gained under the same target drying time or improves the drying time with the same amount of power consumption.

The air guide may comprise an air outlet from which the jet of the heated air exits the air guide, and a cross-sectional area of the air outlet is less than that of the internal space of the housing.

In particular, the cross-sectional area of the air outlet may be less than that of the internal space of the housing at (or proximate to) the heating element. For example, the cross-sectional area of the air outlet may be up to 20%, 10%, 5% or 1% of the cross-sectional area of the internal space (e.g., at or proximate to the heating element).

In a scenario where the heating element is arranged within the internal space of the housing, a cross-sectional dimension of the heating element may be less than that of the internal space of the housing, and the cross-sectional area of the air outlet may be further less than (e.g., up to 20%, 10%, 5% or 1% of) a cross-sectional area of the heating element.

In other words, the housing and/or the air guide restrict a flow of air supplied into the internal space or heated by the heating element. As a result, the jet of the heated air leaving the air outlet would have a greater speed than the air being supplied by the air supply into the internal space of the housing (or the air being heated by the heating element). This arrangement is useful for reducing the power consumption of the air dryer under the same target drying time, because the drying time of the inked image generally decreases by increasing the speed of the heated air directed at the inked image. Further, this arrangement allows the air supply and the heating element to work with less intensity in order to provide the same speed of jet of heated air, thereby prolonging the lifespan of the air supply and the heating element.

It would be appreciated that the term “cross-sectional area” is defined along a plane which is perpendicular to a flowing direction of air through the air dryer.

A width of the air outlet may be between 0.5 and 2 times a print width of the ink jet printer. As such, a width of the jet of the heated air between the air guide and the substrate would substantially match the print width. This is useful for improving the efficiency of the air dryer.

It would be appreciated that the “width” of the air outlet or the “width” of the jet is defined along a direction that is perpendicular to a plane parallel to both the travel direction of the substrate and the travel direction of the jet of the heated air.

The air guide may comprise a constricting nozzle.

By the term “constricting nozzle”, it is meant that an air outlet of the nozzle is of a smaller dimension than an air inlet of the nozzle. It would be understood that the air outlet of the nozzle is the air outlet of the air guide described above.

The constricting nozzle may have an air inlet and an air outlet. A cross-sectional area of the air inlet may be at least 4 times a cross-sectional area of the air outlet. The cross-sectional area of the air inlet may be at least 9 times a cross-sectional area of the air outlet.

The use of a constricting nozzle allows power savings to be gained by using a restricted flow of air under the same target drying time. Further, a restricted flow of air would heat up fewer surrounding components.

The jet of the heated air downstream of the air guide may have a temperature of between 200° C. and 350° C.

Advantageously, this temperature range would not cause a substantial temperature rise in commonly used substrate materials (e.g., cardboard, plastic, glass etc.). Therefore, the air dryer is unlikely to damage the substrate or cause any safety hazard.

The jet of the heated air downstream of the air guide may have a temperature of between 250° C. and 350° C.

It would be understood that the term “downstream” within the expression “the jet of the heated air downstream of the air guide” is defined along a blowing direction of the jet of the heated air. Therefore, “the jet of the heated air downstream of the air guide” refers to a section of the jet which has just exited from the air guide.

The jet of the heated air downstream of the air guide may have a temperature of between 250° C. and 300° C.

The jet of the heated air downstream of the air guide may have a speed that is not greater than 50 m/s with respect to the print head.

With the speed not exceeding 50 m/s, the jet of the heated air causes negligible disruption to the print quality of the inked image.

The jet of the heated air downstream of the air guide may have a speed that is not greater than 30 m/s with respect to the print head.

The jet of the heated air downstream of the air guide may have an air speed in the range of 6 m/s to 50 m/s or 6 m/s to 30 m/s.

The jet of the heated air downstream of the air guide may have a speed in the range of 10 m/s to 20 m/s with respect to the print head.

The air guide may be spaced from the print head by approximately 30 mm to 1500 mm along the direction of travel of the substrate.

Preferably, the air guide may be spaced from the print head by approximately 70 mm to 300 mm along the direction of travel of the substrate.

The air guide may be spaced from the print head by at least 100 mm along the direction of travel of the substrate.

The internal space of the housing may comprise a first flow path and a second flow path, and the air supply may be configured to supply air to both the first and second flow paths. The air dryer may be configured such that the air supplied to the first flow path flows past the heating element so as to generate the jet of the heated air, and that the air supplied to the second flow path does not flow past the heating element so as to generate a jet of cool air. The air guide may be configured to direct the jet of the heated air and the jet of cool air out of the internal space.

It would be understood that the jet of cool air has a lower temperature than the jet of the heated air. While the jet of cool air is not directly heated up by the heating element, the jet of cool air may have a temperature slightly higher than the air originally from the air supply, due to heat exchange between the first flow path and the second flow path.

The jet of cool air acts as an air sheath for the jet of the heated air. The air sheath is useful for increasing a length of the high air speed and high temperature region of the jet of the heated air, thereby reducing the drying time of the inked image.

The air dryer may be configured such that the jet of cool air travels at substantially the same speed as the jet of the heated air.

The air dryer may be configured such that the jet of cool air travels in a direction substantially parallel to a direction along which the jet of the heated air travels.

The air dryer may be configured such that the jet of cool air at least partially surrounds the jet of heated air.

Surrounding the heated air with cool air is useful for preventing ambient entrainment. This arrangement is also beneficial as the energy required to accelerate a sheath of air is small compared to heating up a larger volume of hot air.

The jet of cool air may comprise a plurality of parallel jets of cool air that substantially surround the jet of heated air.

The first flow path may be separated from the second flow path by at least one internal wall within the housing.

The second flow path may substantially surround the first flow path. By surrounding the first flow path (along which the jet of the heated air flows) with the second flow path (along which the jet of cool air flows), the housing of the air dryer may be safe for a user to handle without requiring any thermal insulation sleeve.

The air dryer may further comprise a mounting arrangement on which the housing is mounted.

The mounting arrangement may be configured to hold the housing such that the position and orientation of the air guide is fixed. In this way, the jet of the heated air between the air guide and the substrate may form a fixed angle relative to a direction of travel of the substrate.

The ink jet printer may be a continuous ink jet printer.

The ink jet printer may use a low volatility ink.

The low volatility ink may have a drying time of at least 2 seconds at 25° C. under ambient conditions.

The low volatility ink may have a drying time of at least 5 seconds, at least 10 seconds, at least 15 seconds, or at least 20 seconds at 25° C. under ambient conditions.

The expression “under ambient conditions” means that there is no active heating or air flow provided to the ink.

The low volatility ink may comprise a mixture of water and organic compound.

The low volatility ink may comprise at least 50% by weight of water. The low volatility ink may be substantially water based.

The low volatility ink may comprise less than 20% (or more preferably less than 10% or 5%) by weight of volatile organic compound (e.g., Methyl ethyl ketone).

The ink jet printer may use a water-based ink.

The water-based ink may not comprise any solvent which is a volatile organic compound (e.g., Methyl ethyl ketone).

According to a second aspect of the present disclosure, there is provided an ink jet printing system comprising: an ink jet printer comprising a print head for applying an inked image to a substrate; the air dryer of the first aspect; and a conveyor for moving the substrate past the print head and the air dryer.

The ink jet printing system may further comprise a mounting arrangement on which the air dryer is mountable.

The conveyor may take any suitable form as long as it allows the substrate to be transported past the print head and the air dryer. It would be understood that the conveyor is not limited to a belt conveyor or a roller conveyor. The term “conveyor” may be used interchangeably with a “transport mechanism”.

According to a third aspect of the present disclosure, there is provided a method of drying an inked image printed by an ink jet printer on a substrate, comprising: supplying air into an internal space of a housing; heating the air; and directing a jet of the heated air at the inked image using an air guide in communication with the internal space, wherein the jet of the heated air between the air guide and the substrate forms an angle of between 0 and 30 degrees relative to a direction of travel of the substrate.

The angle may be between 0 and 20 degrees. Further or alternatively, the angle may be between 0 and 15 degrees, 5 and 30 degrees, 5 and 20 degrees or 5 and 15 degrees.

The angle may be approximately 10 degrees.

According to a fourth aspect of the present disclosure, there is provided a method of drying an inked image printed by an ink jet printer using a water-based ink on a substrate, the method comprising: generating and directing hot air at the inked image to dry the inked image within 10 seconds using less than 500 watts electric power consumption.

The generating and directing may comprise generating and directing hot air at the inked image to dry the inked image within 5 seconds using less than 300 watts electric power consumption.

Where appropriate any of the optional features described above in relation to one of the aspects of the disclosure may be applied to another one of the aspects of the disclosure.

It would further be appreciated that the various numerical ranges or values described in the present disclosure allow for a degree of variability, for example, +10%, in the stated values of the end points of the ranges or the stand-alone stated values. For instance, a stated value of 10° may be any number between 10°*(1−10%), and 10°*(1+10%). Further, values expressed in a range format should be interpreted in a flexible manner to include not only the numerical values explicitly recited as the end points of the range, but also to include all the individual numerical values or sub-ranges encompassed within that range as if each numerical value and sub-range is explicitly recited.

### BRIEF DESCRIPTION OF THE DRAWINGS

In order that the disclosure may be more fully understood, a number of embodiments of the disclosure will now be described, by way of example, with reference to the accompanying drawings, in which:

FIG. 1 is a schematic representation of an ink jet printing system comprising an air dryer according to a first aspect of the present disclosure;

FIG. 2 is an enlarged schematic view of an air guide used in the air dryer of FIG. 1;

FIG. 3 is a schematic representation of an ink jet printing system comprising an air dryer according to a second aspect of the present disclosure;

FIG. 4 is a diagram showing measured temperatures of a substrate used in the ink jet printing system of FIG. 1;

FIG. 5 is a diagram showing the relationship between measured maximum temperature rises of a substrate and a temperature of air leaving the air guide in the ink jet printing system of FIG. 1;

FIG. 6 is a photograph of an exemplary air guide used in the air dryer of FIG. 1;

FIG. 7 is a diagram showing the effect of the air temperature on drying time and the substrate temperature;

FIG. 8 is a diagram showing the relationship between drying time and air speed;

FIG. 9 is a diagram showing the relationship between drying time and a distance between the air dryer and a print head of the ink jet printing system of FIG. 1;

FIG. 10 is a schematic representation of an air dryer according to another aspect of the present disclosure;

FIG. 11 is a schematic representation of the air dryer of FIG. 10 when a housing of the air dryer and an outer wall of an air guide are partly removed;

FIG. 12 schematically illustrates (a) a perspective view and (b) a side view at a downstream end of an air guide used in the air dryer of FIG. 10;

FIG. 13 schematically illustrates processing steps of a method for drying an inked image printed by an ink jet printer on a substrate, according to an aspect of the present disclosure;

FIG. 14 schematically illustrates processing steps of a method for drying an inked image printed by an ink jet printer using a water-based ink on a substrate, according to a further aspect of the present disclosure.

It will be appreciated that the drawings are for illustration purposes only and are not drawn to scale.

### DETAILED DESCRIPTION OF THE PREFERRED EMBODIMENTS

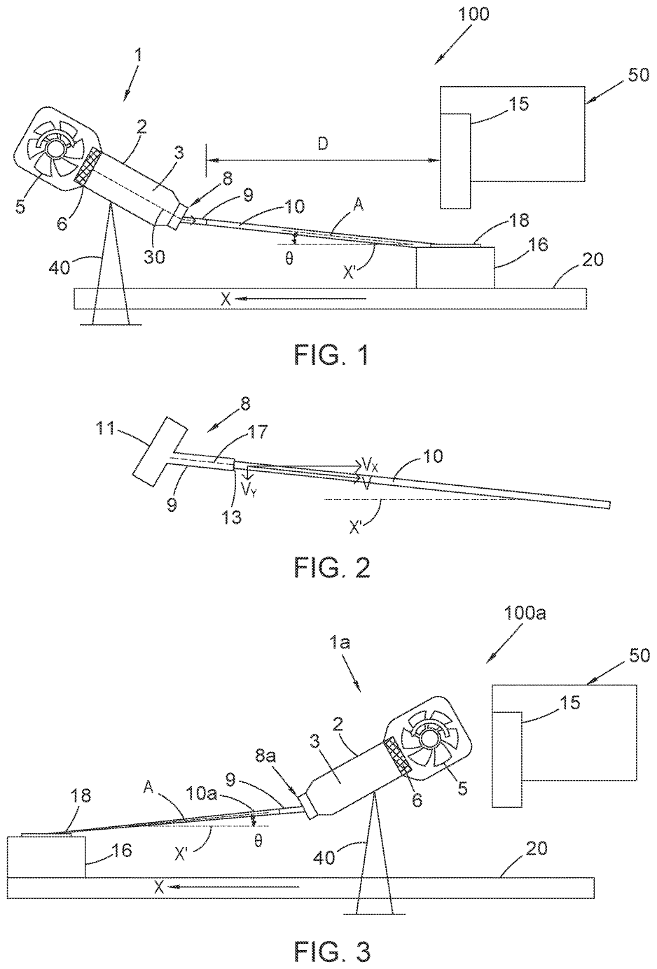

FIG. 1 schematically illustrates an ink jet printing system 100 according to a first embodiment of the present disclosure. The ink jet printing system 100 comprises an ink jet printer 50 having a print head 15, an air dryer 1 and a conveyor 20 that moves a substrate 16 past the print head 15 and the air dryer 1 along a direction X.

The print head 15 generates and directs ink droplets to a surface (e.g., a top surface as shown in FIG. 1) of the substrate 16 as described above, so as to apply an inked image 18 to the surface of the substrate 16. The inked image 18 may be one or more of numbers, letters, bar codes, QR codes, images and/or any other symbolic codes or characters etc. The substrate 16 may be any substrate on which ink is printed, such as, bottles, cans, cartons, packaging or the like. Commonly used material(s) of the substrate 16 include, for example, cardboard, plastic, and/or glass etc.

The ink jet printer 50 may be a continuous ink jet printer. As set out above, if water-based inks are used by the print head 15 to print the inked image 18, the natural drying time of the inked image 18 would be around 20-25 seconds in a typical lab environment. The air dryer 1 is therefore used to reduce the drying time of the inked image 18. The air dryer may also be referred to as a dryer or an ink drying device, which are used interchangeably with the term “air dryer” in the present disclosure.

The air dryer 1 is placed downstream from the print head 15 along the travel direction X of the substrate 16. The substrate 16 with the wet inked image 18 printed thereon then immediately passes the air dryer 1. With reference to FIG. 1, the air dryer 1 includes a housing 2 (which is generally air tight except at its two ends) that encloses an internal space 3 therein, an air supply 5 that supplies air into the internal space 3, a heating element 6 that heats the air supplied into the internal space 3, and an air guide 8 in fluid communication with the internal space 3 such that air supplied into the internal space 3 exits via the air guide 8 at a high speed to generate a jet of heated air 10. A mounting arrangement 40 (e.g., a mounting bracket or frame) is used to hold the air dryer 1 (in particular, the housing 2) in place. It would be appreciated that the mounting arrangement 40 would not obstruct the movement of the substrate 16 or the conveyor 20.

The air guide 8 directs the jet of heated air 10 from the internal space 3 to the inked image 18, so as to accelerate the drying of the inked image 18. The distance between an air outlet of the air guide 8 and the print head 15 along a horizontal direction (e.g., the line X or X′) is labelled as ‘D’ in FIG. 1. The internal space 3 may also be referred to as an air chamber.

The air supply 5 is illustrated as a fan in FIG. 1. However, it would be appreciated that the air supply 5 may take other suitable forms as long as it delivers air under pressure to the internal space 3. For example, the air supply 5 may be a compressor, or an external pressurised air source that is connected to the internal space 3 via an air supply line.

In the example of FIG. 1, the heating element 6 is located between the air supply 5 and the internal space 3, such that air passes through the heating element 6 before entering the internal space 3. Other suitable arrangements of the heating element 6 can be used provided that the supplied air is heated before exiting the internal space 3. For example, depending upon the size and/or geometry of the housing 2, the heating element 6 may be located within the internal space 3 of the housing 2. The heating element 6 may be an electrical heater. In particular, the heating element 6 may comprise a coil, or other controllable heater, and can heat the air in the internal space 3 to a temperature that is preferably in a range of between 200° C. to 350° C.

As shown in FIG. 1, the mounting arrangement 40 holds the housing 2 of the air dryer 1 such that the position and inclination of the air dryer 1 with respect to the print head 15 is fixed. More specifically, the air guide 8 is configured in a way that the jet of heated air 10 between the air guide 8 and the substrate 16 travels along a direction A, and the direction A forms an angle θ relative to an line X′ which is parallel to the travel direction X of the substrate 16.

FIG. 2 shows an enlarged view of the air guide 8. In the example of FIGS. 1 and 2, the air guide 8 is embodied as a nozzle. However, it would be appreciated that the air guide 8 may take various suitable forms, including but not limited to one or more of, a nozzle, a guide vane, and a guide plate with a surface which defines the travelling direction of the jet 10 under Coanda effect. The air guide 8 may be separately provided and then attached to the housing 2. Alternatively, a part or the whole of the air guide 8 may be integrally formed with the housing 2.

With reference to FIG. 2, the air guide 8 has a single air inlet 11, a single air outlet 13, and a tubular structure 9 that defines the air outlet 13. In particular, the airflow downstream end of the tubular structure 9 is the air outlet 13. The tubular structure 9 has a central axis 17, and the heated air 10 leaving the air guide 8 tends to travel along the central axis 17. In other words, the central axis 17 is substantially coincident with the travel direction A of the jet of heated air 10.

The angle θ is defined as the acute angle between two intersecting lines which includes a line which the direction A lies in and the line X′. For two intersecting lines that are not perpendicular to one another, there are always two angles between the lines—an acute angle and an obtuse angle. The angle θ refers to the value of the acute angle between the lines. In the present disclosure, the angle θ is between 0° and 30° (or not greater than) 30°. In this way, the heated air 10 is blowing in a direction close to be in parallel with the line X′ (or the travel direction X of the substrate 16). This arrangement is useful for increasing the contact time between the inked image 18 and the heated air 10, which in turn reduces the drying time of the inked image 18 without consuming more electric power. More preferably, the angle θ is between 0° and 20° (or not greater than) 20° or between 0° and 15° (or not greater than 15°).

The contact time is maximised when the travel direction A of the jet of heated air 10 is parallel to the travel direction X of the substrate 16, i.e., when the angle θ is 0°. However, in such an arrangement, part of the air guide 8 would be at the same height as the inked image 18, and thus the air guide 8 would block the travel path of the substrate 16. Therefore, the angle θ is typically greater than 0° (e.g., not less than) 5°. Accordingly, the angle θ may be any value in a range of between 5° and 30°, between 5° and 20°, between 5° and 15°. In a most preferable embodiment, the angle θ is around 10° for minimizing the dying time of the inked image 18 while still allowing the substrate 16 to travel past the air guide 8.

With further reference to FIG. 2, the jet of heated air 10 which has just exited from the air guide 8 (i.e., downstream of the air guide 8 in the direction A) has a velocity V along the direction A. The velocity V (with respect to the printer 50 or the print head 15) is preferably less than or equal to 50 m/s (metre per second) (e.g., in a range of between 6 m/s and 50 m/s). More preferably, the velocity V does not exceed 30 m/s and may be in a range of between 6 m/s to 30 m/s (more preferably between 10 m/s to 20 m/s). The velocity V of the jet 10 is determined by the volumetric speed of air being supplied into the internal space 3 by the air supply 5 and the cross-sectional area of the air outlet 13 of the air guide 8. The velocity V can be decomposed into a horizontal velocity component V_{X} which is Parallel to the Line X′ (or the Travel Direction X of the Substrate 16) and a vertical velocity component V_{Y} which is perpendicular to the travel direction X of the substrate 16. Because the angle θ is between 0° and 30°, the magnitude of the horizontal velocity component V_{X} is close to the magnitude of the velocity V.

In the example of FIGS. 1 and 2, the jet of heated air 10 is blown into the inked image 18 downstream from the print head 15 in a direction upstream along the path the substrate 16 is moved through the printer 50. In other words, the air guide 8 directs the jet of heated air towards the print head 15 from a location downstream of the print head 15. The term “downstream” used here is with reference to the travel direction X of the substrate 16. The horizontal velocity component V_{X} is thus opposite to the travel direction X of the substrate 16. In this way, the speed of the jet of heated air 10 relative to the substrate 16 is close to a sum of the travelling speed of the jet of heated air 10 and the travelling speed of the substrate 16.

It would be appreciated that in order to achieve the angle of 0° to 30° between the travel direction A and the line X′ (or the travel direction X) as defined above, the air dryer may also be placed in an orientation as shown in FIG. 3. FIG. 3 schematically illustrate an ink jet printing system 100a according to a second embodiment of the present disclosure. Elements of the ink jet printing system 100a that are identical to those of the ink jet printing system 100 are identified using the same labels. Elements that correspond to, but are different from those of the ink jet printing system 100 are labelled using the same numerals but with a letter ‘a’ for differentiation. The features and advantages described above with reference to the first embodiment are generally applicable to the second embodiment. The air dryer 1a of FIG. 3 can be obtained by flipping the air dryer 1 of FIG. 1 horizontally. In particular, the air dryer 1a blows the jet of heated air 10a in a direction downstream along the travelling path of the substrate 16. In other words, the air guide 8a directs the jet of heated air 10a away from the print head 15 from a location downstream of the print head 15. It would be appreciated that in FIG. 3, the horizontal velocity component of the jet of heated air 10a is in the same direction as the travel direction X of the substrate 16. As such, the speed of the jet of heated air 10a relative to the substrate 16 is close to the travelling speed of the jet of heated air 10a minus the travelling speed of the substrate 16.

As described below with reference to FIG. 7, a higher speed of the jet of heated air relative to the substrate 16 would reduce the drying time of the inked image 18. Therefore, blowing the jet of heated air 10 towards the print head 15 (FIG. 1) is more beneficial than blowing the jet of heated air 10a away from the print head 15 (FIG. 3). As compared to the air dryer 1a, the air dryer 1 allows power savings to be gained under the same drying time target.

In the setup of FIG. 1, it would be appreciated that the air speed should be controlled so as to minimize any adverse effect of the air on the printing process. It has been found that when the distance D between the air guide 8 and the print head 15 is not less than around 4 inches (around 10.16 cm), an air speed of 50 m/s (with respect to the print head 15) causes no disruption to the print quality (e.g., legibility or conformance with original design) of the inked image 18 (e.g., applied by a typical continuous ink jet printer). In particular, with the air speed not exceeding 50 m/s, the jet of heated air 10 is unlikely to disrupt the deposition of ink drops on the substrate 16 or to disturb the position of the substrate 16.

Further, as compared to the setup of FIG. 3, the substrate 16 of FIG. 1 tends to move by a much shorter distance from the print head 15 before the inked image is dry enough for subsequent handling. This is because the jet of heated air 10 can act on the inked image 18 immediately after the print head 15 applied the inked image 18. However, in FIG. 3, the substrate 16 with the inked image 18 must travel for a substantial distance before entering into contact with the jet of heated air 10a.

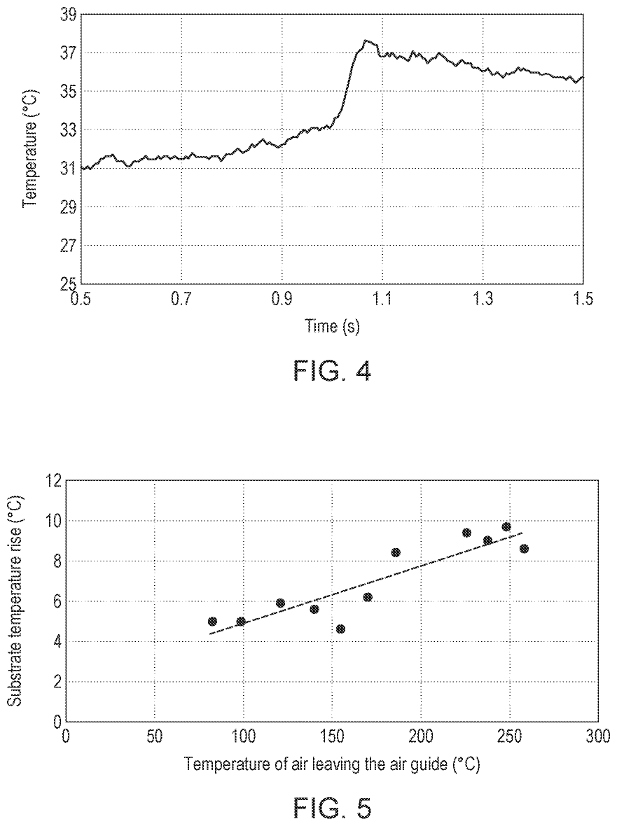

In the event that the substrate 16 contains food or other goods that are sensitive to temperature or that the material(s) of the substrate 16 (e.g., paper, plastics, glass) may be easily damaged by high temperatures, it is preferable that the air dryer 1 would not cause the substrate 16 to experience substantial temperature rise. For example, in some applications the maximum temperature that the substrate 16 can reach is 60° C. FIG. 4 shows experimental data indicating the real-time temperatures of the substrate 16 when it travels past the air dryer 1. The experiment was carried out when the conveyor 20 travelled at a speed of 1.7 m/s and the temperature of the jet of heated air 10 leaving the air guide 8 (i.e., immediately downstream of the air guide 8 along the direction A) was around 200° C. It would be appreciated that in the set-up of FIG. 1, the temperature of the air leaving the air guide 8 is approximately the same as the temperature of the air guide 8 (e.g., proximate to the air outlet 13). Therefore, the temperature of the air leaving the air guide 8 may be measured by using a temperature sensor to sensor the temperature of the air guide 8. A wireless temperature sensor was attached to the top surface of the substrate 16 to continuously monitor the temperature of the substrate 16. It can be seen from FIG. 4 that when the substrate 16 travelled past the contact zone with the heated air 10, the temperature of the substrate 16 increased from around 31° C. to around 37.5° C. FIG. 5 further shows the temperature rises of the substrate 16 at different temperatures of air leaving the air guide 8. Again, the conveyor 20 travelled at a fixed speed of 1.7 m/s. According to FIG. 5, the temperature rise of the substrate 16 increases with the temperature of air leaving the air guide 8. When the temperature of air was 250° C., the temperature rise of the substrate 16 was approximately 10° C. Therefore, the air dryer 1 is unlikely to cause a temperature rise of the substrate 16 that is large enough to be potentially concerning.

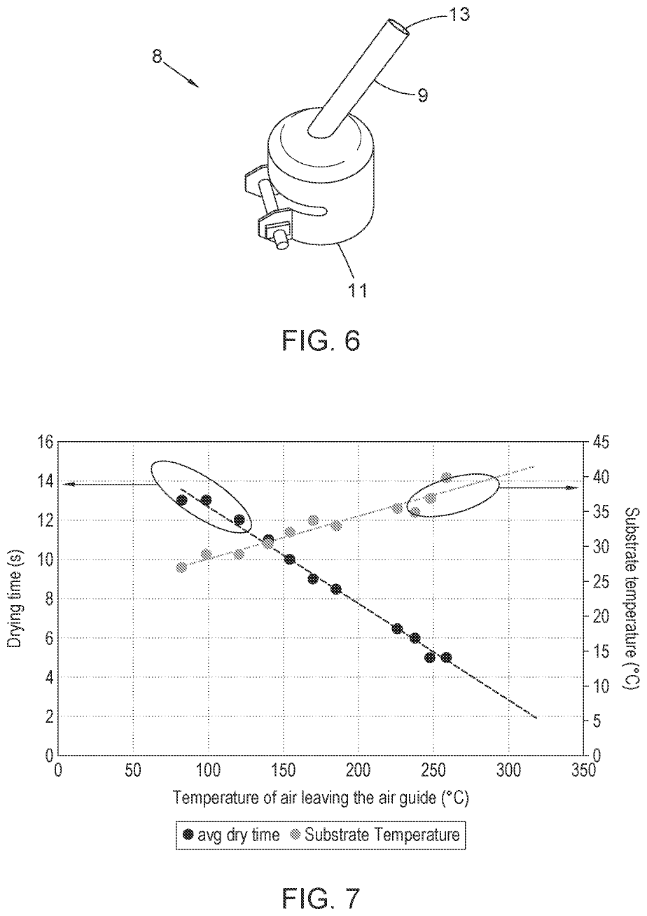

With reference to FIGS. 1 to 2, the air guide 8 is shown as a constricting nozzle, meaning that the air outlet 13 of the air guide 8 is of a smaller cross-sectional area than the air inlet 11 of the air guide 8. In this way, the air speed at the air outlet 13 is greater than the air speed at the air inlet 11 under the same volumetric flow rate. FIG. 6 shows a real-life constricting nozzle which can be used as the air guide 8 of the air dryer 1 (FIG. 1). In the example of FIG. 6, the cross-sectional area of the air inlet 11 is approximately 16 times the cross-sectional area of the air outlet 13.

Table 1 shows various combinations of parameters when the air guide 8 of FIG. 6 is used in the setup of FIG. 1 with the air dryer 1. The experiment was carried out when the conveyor 20 travelled at a speed of 1.7 m/s, and the lab conditions were on average 21° C. and 60% Relative humidity (RH). Under such conditions, the baseline natural drying time of water-based inks applied by a continuous ink jet printer is of the order of 25 seconds.

TABLE 1
the air dryer 1 being used with the air guide 8 of FIG. 6

| Air speed | Air temperature | Power | Drying time |
|---|---|---|---|
| (metre/second) | (° C.) | consumption (Watt) | (second) |
| 13.7 | 250 | 170 | 6 |
| 13.7 | 300 | 240 | 6 |
| 13.7 | 350 | 270 | 5.5 |
| 17.7 | 250 | 259 | 5 |
| 17.7 | 300 | 290 | 5 |
| 31.7 | 250 | 350 | 3.5 |

A set of pneumatic pistons with rubber ring wipers (not shown in FIG. 1) were used to determine the drying time of the inked image 18. The pneumatic pistons with rubber ring wipers were placed downstream from the air dryer 1 along the travel direction X of the substrate 16. The pneumatic pistons had individually adjustable time delays and were designed to mimic thumb rub of the inked image 18. If the inked image 18 is not smeared by the rubber wing wipers, it is meant that the inked image 18 is sufficiently dry for subsequent handling.

In Table 1, the air speed refers to the speed of the jet of heated air 10 downstream of the air outlet 13 with respect to the conveyor 20. For simplicity, the air speed was considered as a sum of the speed of the jet 10 (with respect to the still printer 50) and the speed of the conveyor 20 (with respect to the still printer 50) without taking into account the angle θ. With the speed of the conveyor 20 being 1.7 m/s, the speed of the jet of heated air with respect to the printer 50 was 12 m/s, 16 m/s and 30 m/s in Table 1. The air temperature indicates the temperature of the jet of heated air 10 immediately downstream of the air guide 8 along the direction A. The power consumption refers to the total power consumed by the air supplier 5 and the heating element 6 of the air dryer 1. The drying time refers to the drying time of the inked image 18 (which was printed by water-based inks). It can be seen that with the air guide 8 of FIG. 6, the air dryer 1 can achieve a drying time of 5 seconds under less than 300W (in particular 259W and 290W) of power consumption.

TABLE 2
the air dryer 1 being used without a constricting nozzle

| Air speed | Air temperature | Power | Drying time |
|---|---|---|---|
| (metre/second) | (° C.) | consumption (Watt) | (second) |
| 17.7 | 250 | 1400 | 3.5 |
| 7.7 | 376 | 810 | 3.5 |
| 13.7 | 250 | 1110 | 4 |
| 7.7 | 320 | 750 | 4.5 |
| 9.7 | 250 | 920 | 4.5 |
| 7.7 | 295 | 695 | 6 |
| 7.7 | 250 | 650 | 7 |

A contrasting experiment was also carried out under the same experimental settings (under which Table 1 was obtained) but without using a constricting nozzle such as the one shown in FIG. 6. Rather, a nozzle with a much wider air outlet was used as the air guide 8. Table 2 shows various combinations of parameters obtained from the contrasting experiment.

As shown by Table 2, in order to provide a drying time of less than 5 seconds, the power consumption of the air dryer 1 was much higher than that in the setup which involved the use of a constricting nozzle as the air guide 8.

By comparing Table 1 with Table 2, it can be seen that the use of a constricting nozzle as the air guide 8 is beneficial for reducing the power consumption of the air dryer 1 under the same target drying time. This is because the air guide 8 (i.e., constricting nozzle) constricts the air flow from the housing 2. Accordingly, to provide the same air speed, a lower volumetric flow rate is required from the air supply 5 which therefore consumes less power. Further, to generate and to heat up the lower volumetric flow rate of air, the work intensities of the air supply 5 and the heating element 6 can be reduced, thereby prolonging the lifespan of the air supply 5 and the heating element 6. The smaller air outlet and the lower overall volumetric flow also meant that the heat and speed of the air were reduced in a much shorter distance from the air guide 8. Further, a restricted flow of air as provided by the air guide 8 would heat up fewer surrounding components.

To provide substantial power savings, a cross-sectional area of the air inlet 11 may be at least 4 times a cross-sectional area of the air outlet 13. More preferably, the cross-sectional area of the air inlet 11 is at least 9 times the cross-sectional area of the air outlet 13.

In the above example, the constriction of air flow is primarily provided by the air guide 8. It would be appreciated that further or alternatively, the housing 2 may be tapered to constrict the air flow supplied by the air supply 5 and/or heated by the heating element 6. For example, the housing 2 may have a smaller outlet than its inlet (where air supplied by the air supply 5 is received by the housing 2 and heated up by the heating element 6). In that case, even if the air guide 8 is of a non-constricting profile (e.g., the air outlet 13 is of the same size as the air inlet 11), the shape of the housing 2 itself may be sufficient to provide a constricted jet of heated air 10 thereby enabling power savings of the air dryer 1. Generally speaking, the constriction of air flow through the air dryer 1 can be provided by making the air outlet 13 of the air guide 8 to have a smaller cross-sectional area than the internal space 3 of the housing 1 at or proximate to the heating element 6. To provide noticeable power savings, the cross-sectional area of the air outlet 13 of the air guide 8 may be up to 20%, 10%, 5% or 1% of the cross-sectional area of an air inlet (proximate to the heating element 6) of the internal space. It would be appreciated that the “cross-sectional” area described above is defined along a plane which is perpendicular to a flowing direction 30 (FIG. 1) of air through the air dryer 1. In the example of FIG. 1, the flowing direction 30 is generally coincident with a central axis of the housing 2 and a central axis of the air guide 8.

Further, it would be understood that the size of the air outlet 13 of the air guide 8 may be selected based upon the print width (described above) of the ink jet printer 50. To maximise the efficiency of the air dryer 1, a width of the jet of heated air 10 may match the print width, such that the jet of heated air 10 would not substantially impinge on an area of the substrate 16 that is beyond the boundary of the inked image 18. In general, the width of the air outlet 13 may be between 0.5 and 2 times the print width. In the example of FIG. 1, the print width of the ink jet printer 50 is typically defined along a direction that is perpendicular to the direction X on the top surface of the substrate 16. Thus the width of the jet of heated air 10 or the width of the air outlet 13 is defined along the same direction (i.e., perpendicular to both the directions A and X).

As described above, the drying time of the inked image 18 is affected by the contact time between the inked image 18 and the jet of heated air 10 (hence the angle θ). It has been found by the inventors of the present disclosure that the drying time of the inked image 18 is also affected by the following factors: (1) the temperature of the jet of heated air 10; (2) the speed of the jet of heated air 10 relative to the substrate 16; (3) the distance between the air guide 8 and the print head 15. This is described below with reference to FIGS. 7 to 9.

FIG. 7 is a diagram showing the effect of the air temperature on drying time and the substrate temperature. The data of FIG. 7 was obtained using the setup of FIG. 1. The X-axis of FIG. 7 is the temperature of the jet of heated air 10 immediately downstream of the air guide 8 along the direction A. The Y-axis on the left side of FIG. 7 (“drying time”) is the drying time of the inked image 18. The Y-axis on the right side of FIG. 7 (“substrate temperature”) is the temperature of the substrate 16. The data of FIG. 7 were obtained when the conveyor 20 travelled at a speed of 1.7 m/s, the humidity of the ambient was 60% and the speed of the jet of heated air 10 downstream of the air guide 8 (with respect to the still printer 50 without taking into account the speed of the conveyor 20) was 2.7 m/s. Under such conditions, the baseline natural drying time of water-based inks applied by a continuous ink jet printer is of the order of 25 seconds.

FIG. 7 shows that the drying time of the inked image 18 reduces significantly with the increase of the air temperature. When the air temperature was 250° C., the drying time of the inked image was around 4.75 seconds, providing 81% reduction of the baseline drying time. Therefore, the temperature of the jet of heated air 10 has a significant impact on the drying time of the inked image 18. FIG. 7 further shows that the substrate temperature was around 27° C. when the air temperature was 80° C. and that the substrate temperature was around 40° C. when the air temperature was 260° C. Therefore, while the temperature of the substrate 16 does increase with the air temperature, the air temperature however has a small effect on the maximum substrate temperature generated. FIG. 7 confirms the findings of FIGS. 4 and 5 that the air dryer 1 is unlikely to cause a significant temperature rise of the substrate 16. The temperature of the jet of heated air 10 downstream of the air guide 8 is preferably in a range of between 250° C. and 300° C., so as to keep the substrate temperature low.

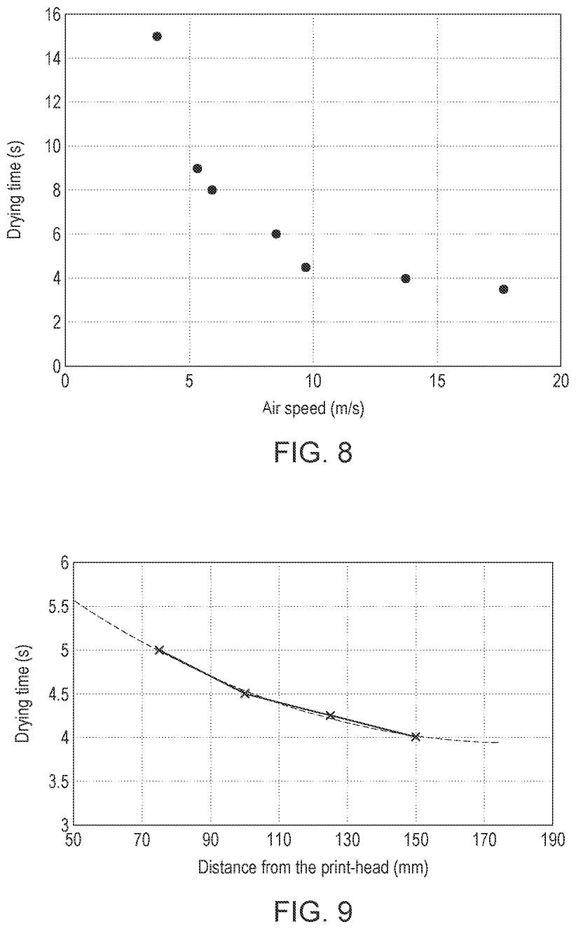

FIG. 8 is a diagram showing the relationship between drying time and air speed. The data of FIG. 8 was obtained using a large fan setup (which is similar to the setup of FIG. 1 but without the constricting air guide 8). The X-axis of FIG. 8 (“air speed”) is the speed of the jet of heated air 10 generated by the air dryer 1 with respect to the conveyor 20. For simplicity, the air speed was considered as a sum of the speed of the jet of heated air 10 (with respect to the still printer 50) and the speed of the conveyor 20 (with respect to the still printer 50) without taking into account the angle θ. The Y-axis (“drying time”) is the drying time of the inked image 18. The testing was performed with 260° C. air. FIG. 8 shows that the drying time was reduced by increasing the air speed. In particular, when the air speed increased from 3 m/s to around 10 m/s, the drying time was significantly reduced. Beyond the air speed of 10 m/s, the drying time was slowly reduced. Therefore, for the setup for FIG. 8, an air speed of around 10 m/s was considered the optimal air speed because it gave the largest benefit with the lowest power consumption. It would be appreciated that the optimal air speed may vary with the particular geometry of air guide 8 (e.g., the cross-sectional size of the outlet 13 of the air guide 8) used with the air dryer 1.

FIG. 9 was obtained using the setup of FIG. 1. It is a diagram showing the relationship between the drying time of the inked image 18 (Y-axis) and the distance D between the air guide 8 and the print head 15 along a horizontal direction (X-axis). The testing was performed with 200° C. heated air 10 and an air speed of 16 m/s (with respect to the still printer 50). FIG. 9 shows that the drying time decreased as the air dryer 1 was moved away from the print head 15. This is because the distance D affects the amount of time the substrate 16 would spend in the jet of heated air 10. A greater distance D increases the contact time between the substrate 16 and the jet of heated air 10, thereby reducing the drying time of the inked image 18. In general, there is a trade-off between space required on a production line and the drying time. Further, it would be appreciated that once the distance D reaches a sufficient level, the effect of the distance on the drying time would diminish. This is shown by FIG. 9 in which the slope of the curve became flatter above 100 mm. In general, the distance D is preferably in a range of between 30 mm and 1500 mm. More preferably, the distance D is in a range of between 70 mm and 300 mm, and/or not less than 100 mm.

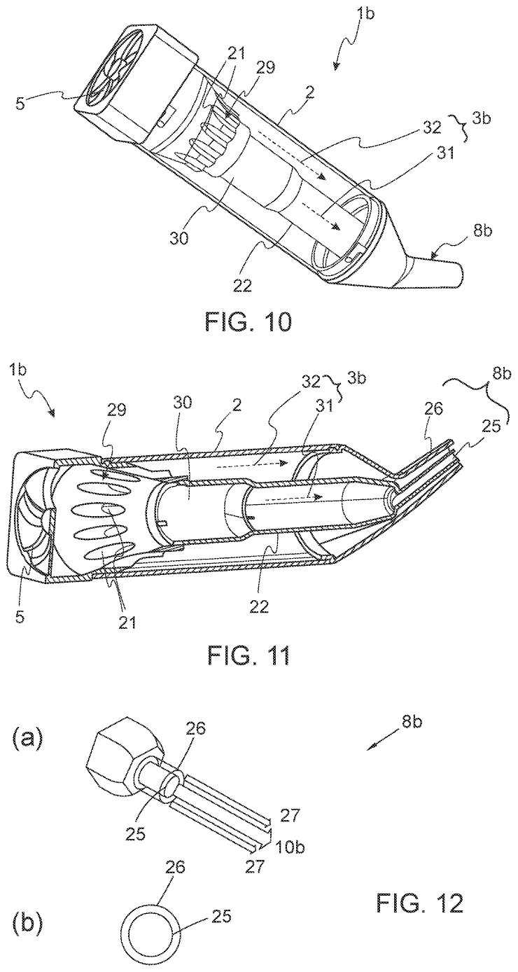

FIGS. 10 to 12 schematically show an air dryer 1b according to another embodiment. Elements of the air dryer 1b that are identical to those of the air dryer 1 of FIG. 1 are identified using the same labels. Elements that correspond to, but are different from those of the air dryer 1 are labelled using the same numerals but with a letter ‘b’ for differentiation. The features and advantages described above with reference to the first embodiment are generally applicable to this embodiment.

The air dryer 1b is differentiated from the air dryer 1 in that the air dryer 1b ejects both a jet of heated air 10b (FIG. 12) and a jet of cool air 27 (FIG. 12), with the jet of cool air 27 forming an air sheath surrounding the jet of heated air 10b.

To provide the cool air sheath, the internal space 3b of housing 2 comprises a first flow path 31 and a second flow path 32 which are separated by a divider 22. The directions of air flow within the flow paths 31, 32 are schematically illustrated by dashed arrows in FIGS. 10 and 11. The divider 22 is located within the housing 2 and is generally cylindrical. In particular, the first flow path 31 is defined as the space surrounded by the divider 22, and the second flow path 32 is defined as the space between the divider 22 and the housing 2. In other words, the second flow path 32 surrounds the first flow path 31.

The air supply 5 of the air dryer 1b supplies cool air from the ambient environment to each of the first and second flow paths 31, 32. As shown by FIGS. 10 and 11, an air splitter 29 is arranged between the air supply 5 and the first and second flow paths 31, 32. The air splitter 29 is of a conical shape with holes 21 extending through its sidewall. The conical shape directs part of the supplied air into the first flow path 31. The remaining part of the supplied air enters the second flow path 32 via the holes 21.

A heating chamber 30 enclosing a heating element (not shown) is located between the air splitter 29 and the first flow path 31. Thus, the heating element heats up the air entering the first flow path 31. The air entering the second flow path 32 however does not pass through the heating element. Therefore, the heating element does not directly heat up the air supplied into the second flow path 32. However, due to heat exchange between the first and second flow paths 31, 32, the air temperature within the second flow path 32 may still be slightly higher than the air temperature originally from the air supply 5. Since the second flow path 32 surrounds the first flow path 31, the housing 2 of the air dryer 1b may be safe for a user to handle without requiring any thermal insulation sleeve.

The air guide 8b of the air dryer 1b comprises a first nozzle 25 and a second nozzle 26. The first nozzle 25 is in fluid communication with the first flow path 31. The space between the first and second nozzles 25, 26 is in fluid communication with the second flow path 32. As shown by FIGS. 11 and 12, each of the first and second nozzles 25, 26 is a constricting nozzle similar to that shown by FIG. 2. Further, as shown by FIG. 12(b), the second nozzle 26 surrounds the first nozzle 25 and has a greater dimension than the first nozzle 25. As a result, heated air from the first flow path 31 ejects out of the first nozzle 25 to form a jet of heated air 10b. Unheated cool air from the second flow path 32 ejects out of the second nozzle 26 to form a jet of cool air 27, through the space between the sidewall of the first nozzle 25 and the sidewall of the second nozzle 26. In this way, the jet of cool air 27 forms an air sheath surrounding the jet of heated air 10b.

The air dryer 1b can be used in a similar way to the air dry 1 in the ink jet printing system 100 of FIG. 1 or the air dryer 1a in the ink jet printing system 100a of FIG. 3. In particular, the air guide 8b is angled such that the jet of heated air 10b leaving the first nozzle 25 of the air guide 8b travels along a direction close to be in parallel with the travel direction X of the substrate 16. Preferably, the jet of cool air 27 travels in a direction substantially parallel to the travel direction of the jet of heated air 10b. Further, the jet of cool air 27 preferably travels at a similar speed to the jet of heated air 10b.

Surrounding the jet of heated air 10b with the jet of cool air 27 is useful for preventing ambient entrainment, because the jet of cool air 27 isolates the jet of heated air 10b from the ambient atmosphere. This arrangement is also beneficial as the energy required to accelerate a sheath of air is small compared to heating up a larger volume of hot air. Further, the jet of cool air 27 is useful for increasing the length of the high speed and high temperature region of the jet of heated air 10b. This would reduce the drying time of the inked image 18 as the active drying length of the jet of heated air 10b would increase.

It would be appreciated that the first and second flow paths 31, 32 and/or the air guide 8b may take different forms than those described above. In the example of FIGS. 10 and 11, the jet of cool air 27 is of an annular shape fully surrounding the jet of heated air 10b. It would be appreciated that the air guide 8b may be modified such that the jet of cool air 27 partially surrounds the jet of heated air 10b. Further, the divider 22 separating the first and second flow paths 31, 32 may not be air tight, and may comprise hole(s). The divider 22 may not be cylindrical, and/or may not share the same central axis the housing 2. In other examples, the divider 22 may be replaced by a guide vane which generates a jet of heated air flowing through the central region of the internal space 3b; and the air guide 8b may be replaced by flow straighteners which eject multiple parallel jets of air, with the middle jet(s) of air being jet(s) of heated air and the peripheral jets of air being jets of cool air. The jets of cool air generated by flow straighteners would substantially but not completely surround the jet(s) of heated air. Further, the air splitter 29 may be of a different design and may not be conical.

In the example of FIGS. 10 and 11, the heating element (enclosed by the heating chamber 30) is arranged within the internal space 3b of the housing 2. To achieve noticeable power savings and also to prolong the lifespan of the heating element (via the constriction of air flow as described above), a cross-sectional area of an air outlet of the first nozzle 25 (through which the jet of heated air 10b exits the air guide 8b) may be up to 20%, 10%, 5% or 1% of a cross-sectional area of the heating chamber 30 (or the heating element).

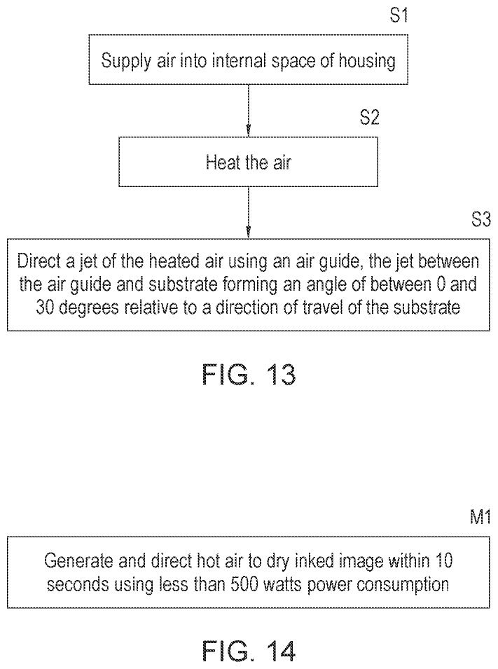

FIG. 13 schematically illustrates processing steps of a method of drying an inked image (e.g., the inked image 18) printed by an ink jet printer (e.g., the printer 50) on a substrate (e.g., the substrate 16).

At step S1, air is supplied into an internal space (e.g., the internal space 3 or 3b) of a housing (e.g., the housing 2).

At step S2, the air is heated, e.g., by a heating element 6.

At step S3, a jet of the heated air (e.g., the jet 10, 10a or 10b) is directed at the inked image using an air guide (e.g., the air guide 8, 8a, 8b) in communication with the internal space. The air guide is configured such that the jet of heated air between the air guide and the substrate forms an angle of between 0 and 30 degrees relative to a direction of travel (e.g., direction X) of the substrate. The definition of the angle is similar to that of the angle θ as described above in relation to FIGS. 1 and 3.

It would be appreciated that the steps may be performed in a temporal order that is different from the order of description. For example, steps S2 may be performed before step S1, and/or simultaneously with step S1.

FIG. 14 schematically illustrates processing steps of a method of drying an inked image (e.g., the inked image 18) printed by an ink jet printer (e.g., the printer 50) using a water-based ink on a substrate (e.g., the substrate 16).

At step M1, hot air (e.g., the jet of heated air 10, 10a or 10b) is generated and directed at the inked image to dry the inked image within 10 seconds using less than 500 watts electric power consumption.

Optionally, the hot air may be generated and directed at the inked image to dry the inked image within 5 seconds using less than 300 watts electric power consumption.

Step M1 may comprise sub-steps such as steps S1 to S3 described above.

While the air dryer described in the present disclosure is particularly beneficial for use with a continuous ink jet printer operating with water-based inks, it would be appreciated that the air dryer may be used with other types of ink jet printers (e.g., drop on demand ink jet printers) and/or other types of inks (e.g., low volatility inks) to reduce the drying time of printed inked images. Low volatility inks (especially those in which a mixture of water and volatile organic compound(s) collectively act as the solvent) may be used to reduce the amount of CMR/VOC being evaporated into the environment during operation of ink jet printers. The drying time of low volatility inks may be at least 2 seconds, 5 seconds, 10 seconds, 15 seconds or 20 seconds at room temperature (e.g., 25°) under ambient conditions (e.g., 60% RH without active heating or air flow), depending upon the percentage of the volatile organic compound(s) within the mixture. In terms of ink composition, low volatility inks may comprise at least 50% by weight of water, or less than 20% (or more preferably less than 10% or 5%) by weight of volatile organic compound(s) (e.g., Methyl ethyl ketone). The air dryer may also be used with high volatility or fast dry inks (e.g., MEK or Ethanol-based inks) if there is a need to further reduce the drying time of those inks so as to increase a line speed of the production lines.

Further, while the embodiments described above heat and direct hot air to the inked image, it would be appreciated that other type(s) of gas (e.g., N₂, CO₂) may be used in a similar way to accelerate the drying time of the inked image. In that case, the terms “air dryer”, “air supply”, “air guide”, “jet of heated air” and “jet of cool air” described above may be referred to more generally as dryer, gas supply, gas guide, jet of heated gas and jet of cool gas, respectively.

The terms “having”, “containing”, “including”, “comprising” and the like are open and the terms indicate the presence of stated structures, elements or features but not preclude the presence of additional elements or features. The articles “a”, “an” and “the” are intended to include the plural as well as the singular, unless the context clearly indicates otherwise.

The skilled person will understand that in the preceding description and appended claims, positional terms such as ‘top’, ‘horizontal’, ‘vertical’, etc. are made with reference to conceptual illustrations of an ink jet printing system, such as those shown in the appended drawings. These terms are used for ease of reference but are not intended to be of limiting nature. These terms are therefore to be understood as referring to an element when in an orientation as shown in the accompanying drawings.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the disclosure, whether alone or in any appropriate combination with any other feature disclosed or illustrated herein.

1. An air dryer for use with an ink jet printer comprising a print head for applying an inked image to a substrate, wherein the air dryer comprises:
a housing enclosing an internal space therein;
an air supply configured to supply air into the internal space of the housing;
a heating element configured to heat the air; and
an air guide in communication with the internal space for directing a jet of the heated air at the inked image on the substrate so as to dry the inked image, and wherein the air guide is configured such that the jet of the heated air between the air guide and the substrate forms an angle of between 0 and 30 degrees relative to a direction of travel of the substrate.

2. The air dryer of claim 1, wherein the air guide comprises a nozzle.

3. The air dryer of claim 1, wherein the angle is between 0 and 20 degrees.

4. (canceled)

5. The air dryer of claim 1, wherein the air guide comprises a tubular structure through which the jet of the heated air exits the internal space, and wherein the tubular structure forms an angle of between 0 and 30 degrees relative to the direction of travel of the substrate.

6. The air dryer of claim 1, wherein the air guide is configured such that the jet between the air guide and the substrate has a velocity component that is opposite to the direction of travel of the substrate.

7. The air dryer of claim 1, wherein the air guide comprises an air outlet from which the jet of the heated air exits the air guide, and a cross-sectional area of the air outlet is less than that of the internal space of the housing.

8. The air dryer of claim 7, wherein a width of the air outlet is between 0.5 and 2 times a print width of the ink jet printer.

9. The air dryer of claim 1, wherein the air guide comprises a constricting nozzle.

10. The air dryer of claim 1, wherein the jet of the heated air downstream of the air guide has a temperature of between 200° C. and 350° C.

11. (canceled)

12. The air dryer of claim 1, wherein the jet of the heated air downstream of the air guide has a speed that is not greater than 50 m/s with respect to the print head.

13. (canceled)

14. The air dryer of claim 1, wherein the air guide is spaced from the print head by at least 100 mm along the direction of travel of the substrate.

15. The air dryer of claim 1, wherein:
the internal space of the housing comprises a first flow path and a second flow path, and the air supply is configured to supply air to both the first and second flow paths;
the air dryer is configured such that the air supplied to the first flow path flows past the heating element so as to generate the jet of the heated air, and that the air supplied to the second flow path does not flow past the heating element so as to generate a jet of cool air; and
the air guide is configured to direct the jet of the heated air and the jet of cool air out of the internal space.

16. The air dryer of claim 15, wherein the air dryer is configured such that the jet of cool air travels at substantially the same speed as the jet of the heated air.

17. The air dryer of claim 15, wherein the air dryer is configured such that the jet of cool air travels in a direction substantially parallel to a direction along which the jet of the heated air travels.

18. The air dryer of claim 15, wherein the air dryer is configured such that the jet of cool air at least partially surrounds the jet of heated air.

19. The air dryer of claim 1, further comprising a mounting arrangement on which the housing is mounted.

20-22. (canceled)

23. The air dryer of claim 1, wherein the air dryer is part of an ink jet printing system that includes the ink jet printer; and
a conveyor for moving the substrate past the print head and the air dryer.

24. A method of drying an inked image printed by an ink jet printer on a substrate, comprising:
supplying air into an internal space of a housing;
heating the air; and
directing a jet of the heated air at the inked image using an air guide in communication with the internal space, wherein the jet of the heated air between the air guide and the substrate forms an angle of between 0 and 30 degrees relative to a direction of travel of the substrate.

25. A method of drying an inked image printed by an ink jet printer using a water-based ink on a substrate, the method comprising:
generating and directing hot air at the inked image to dry the inked image within 10 seconds using less than 500 watts electric power consumption.

26. The ink jet printing system of claim 23, wherein the ink jet printer is a continuous ink jet printer; and/or the ink jet printer uses a low volatility ink.
